(19) United States
(12) Patent Application Publication
(10) Pub. No.: US 2005/0255948 A1
(43) Pub. Date: Nov. 17, 2005

(54) Power transmission system of vehicle

(75) Inventor: Mitsugi Chonan, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/123,006

(22) Filed: May 6, 2005

(30) Foreign Application Priority Data
May 10, 2004 (JP) 2004-140271

(51) Int. Cl. F16H 63/00

(52) U.S. Cl. 474/23

(57) ABSTRACT

The power transmission system for the vehicle of the present invention comprises a transmission having an input shaft and an output shaft, the input shaft being operatively connected to an engine, a counter shaft provided in parallel with the output shaft of the transmission, a forward gear train provided between the output shaft of the transmission and the counter shaft and a final reduction gear train provided between the counter shaft and an axle, the axle being operatively connected to the driving wheel. The forward gear train includes a gear having a disk portion mounted on the shaft and a circular gear portion fitted on an external circumference of the disk portion.

### TECHNICAL FIELD OF THE INVENTION

The present invention relates to a power transmission system including a belt-type continuously variable transmission to transmit power from the engine to driving wheels of a vehicle.

### BACKGROUND OF THE INVENTION

A vehicle of running in unleveled land as called a buggy or ATV (All Terrain Vehicle) is one-seater off-road four-wheeled vehicle, which is utilized for leisure such like hunting or trail-touring, and other than that, in part, agricultural vehicle. In such ATV, the power transmission system for transmitting power from an engine to the driving wheels is provided with the belt-type continuously variable transmission to which rotation of a crankshaft of the engine is input via a centrifugal clutch; a forward and reverse switching mechanism to be mounted between a secondary shaft which is an output shaft of the continuously variable transmission and a counter shaft; and a final reduction gear train provided in-between the forward and reverse switching mechanism and the driving wheels.

There are many cases that the ATV jumps when driving. Since, at the time of jumping, a load from a ground is not added to the driving wheels, revolution numbers of the engine and the driving wheels are increased. After the vehicle jumping, i.e. when landing, an excess spike torque adds to the power transmission system by a difference of the revolution numbers of between the engine and the driving wheels. Therefore, in the conventional art, as described in Japanese Patent Application Laid-Open No. 2002-68070, the power transmission system is configured that a final reduction driven gear in the final reduction gear train is press-fit into the output shaft. Depending on a press fitting tolerance between the final reduction driven gear and the output shaft, at the time of landing after the vehicle jumping, the spike torque equal or more than a predetermined value causes a slippage of the final reduction driven gear with respect to the output shaft.

However, according to the conventional art, in order to prevent the entrance of the excess spike torque into the power transmission system from the driving wheels, the press fitting tolerance between the final reduction driven gear and the output shaft is designed to be tight. Therefore, repeated slips of the final reduction driven gear on the output shaft cause significant wear thereat and make the press fitting tolerance loose. Then, even in normal high load driving, slip occurs between the final reduction driven gear and the output shaft, which generates not only a heat problem but also a difficulty of normal driving. Further, there is a difficulty in setting the press fitting tolerance as the torque limiter.

### SUMMARY OF THE INVENTION

An object of the present invention is, when excess torque is input to the power transmission system from the driving wheels, to block torque transmission in a forward and reverse switching mechanism, thereby protecting the power transmission system.

The power transmission system for the vehicle of the present invention comprises a transmission having an input shaft and an output shaft, the input shaft being operatively connected to an engine, a counter shaft provided in parallel with the output shaft of the transmission, a forward gear train provided between the output shaft of the transmission and the counter shaft and a final reduction gear train provided between the counter shaft and an axle, the axle being operatively connected to the driving wheel. The forward gear train includes a gear having a disk portion mounted on the shaft and a circular gear portion fitted on an external circumference of the disk portion.

The power transmission system of the present invention further comprises a forward and reverse changeover mechanism provided on the counter shaft to change over vehicle driving mode between a forward driving and a reverse driving. The driven gear is provided for the forward driving and operatively coupled to the counter shaft by the forward and reverse changeover mechanism at the selection of the forward driving.

In the power transmission system of the present invention, the transmission is a continuously variable transmission having a primary pulley, a secondary pulley and a driving belt wound over the primary pulley and secondary pulley.

In the power transmission system of the present invention, the disk portion and the circular gear portion of the driven gear are fitted each other and at least one of the surfaces of the disk portion and the circular gear portion is processed to be low friction surface.

According to the present invention, the driven gear of the gear train mounted on the counter shaft of the transmission such as belt-type continuously variable transmission is formed of the disk portion and the circular gear portion fitted into the external circumference of the disk portion as a torque limiter mechanism which operates to shut out the spike torque inputting to the power transmission from the driving wheels. Since such torque limiter mechanism is disposed at the engine side than the final reduction gear train, an acceptable value of the torque limiter value can be set smaller and it is easy to set the acceptable value. Because the torque limiter structure is employed with respect to the driven gear disposed in the case, it can prevent a foreign body such as dusts from entering from outside in the fitting portion of the torque limiter structure.

### BRIEF DESCRIPTION OF THE DRAWINGS

FIG. 1 is a perspective view showing an example of all terrain vehicle.

FIG. 2 is a schematic view showing power transmission system to be mounted on the all terrain vehicle as shown in FIG. 1.

FIG. 3 is a cross sectional view along a line A-A in FIG. 2.

FIG. 4 is an enlarged cross sectional view showing a part of FIG. 2.

FIG. 5 is a cross sectional view along a line B-B in FIG. 4.

FIG. 6 is a plan view showing the switching plate as shown in FIG. 5.

### DESCRIPTION OF THE PREFERRED EMBODIMENTS

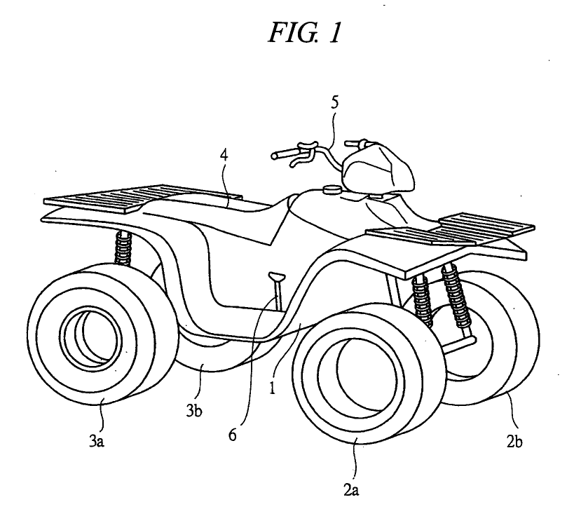

Hereinafter, the preferred embodiment of the present invention will be described in detail with reference to the drawings. FIG. 1 is a perspective view showing one example of a rough terrain vehicle or an all-terrain vehicle, i.e. ATV which is also called a buggy. A vehicle body 1 is provided with front wheels 2a, 2b and rear wheels 3a, 3b as driving wheels. A saddle type seat 4 is provided in the center of the vehicle body 1. A driver sitting on the seat 4 operates a handlebar 5 to drive the vehicle 1.

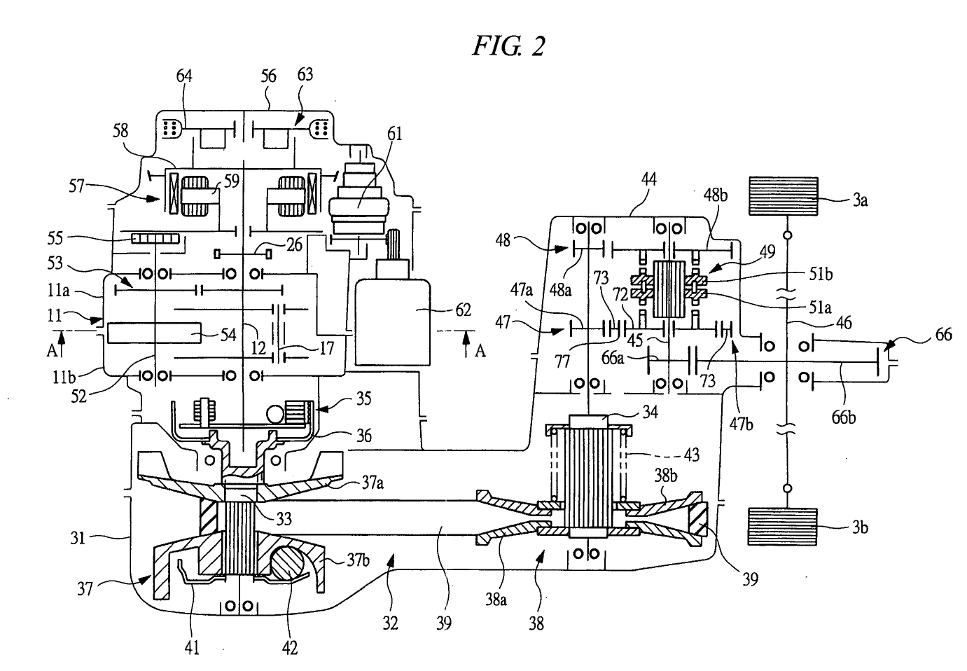

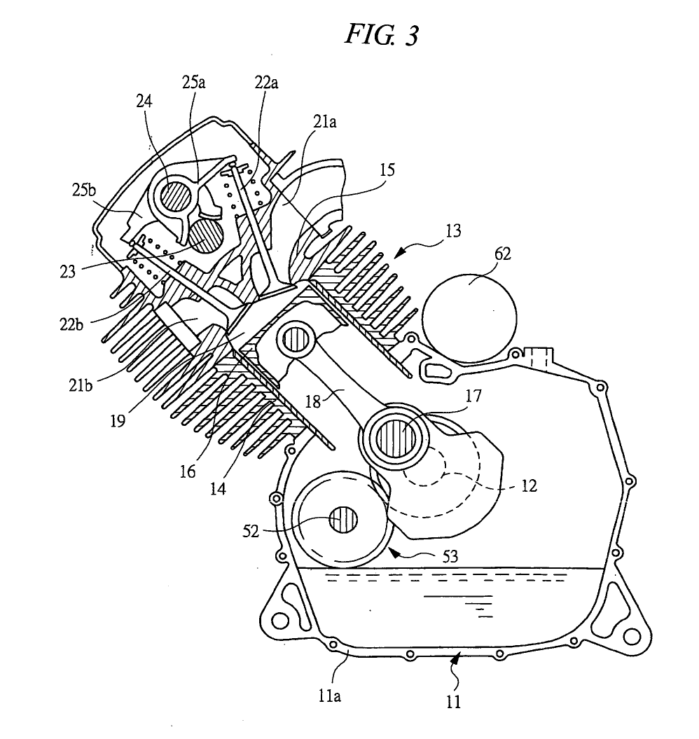

FIG. 2 is a schematic view showing a power transmission system mounted on the all-terrain vehicle shown in FIG. 1. FIG. 3 is a cross sectional view along a line A-A in FIG. 2. As shown in FIG. 2, a crankshaft 12 of an engine 13 is rotatably mounted in a crankcase 11 which is assembled by confronting a first case body 11a and a second case body 11b each other. As shown in FIG. 3, the engine 13 has a cylinder 14 connected to the crankcase 11 and a cylinder head 15 fixed at a top of the cylinder 14. Inside the cylinder bore at the cylinder 14, a piston 16 is assembled in such a way as to freely reciprocate. A connecting rod 18 is coupled between a crank pin 17 of the crankshaft 12 and the piston 16.

As shown in FIG. 3, an intake port 21a communicated to a combustion chamber 19 is formed in the cylinder head 15 and an intake valve 22a for opening or closing the intake port 21a is mounted on the cylinder head 15. Then, an exhaust port 21b communicated to the combustion chamber 19 is formed in the cylinder head 15 and an exhaust valve 22b for opening or closing the exhaust port 22b is mounted on the cylinder head 15. A camshaft 23 is rotatably mounted on the cylinder head 15. A rocker arm 25a for moving the intake valve 22a and a rocker arm 25b for moving the exhaust valve 22b are rotatably mounted on a rocker shaft 24 provided in parallel to the camshaft 23. As shown in FIG. 2, a sprocket 26 is fixed to the crankshaft 12. A timing chain (not shown) is looped between a sprocket not shown fixed to the camshaft 23 and the sprocket 26. The intake valve 22a and exhaust valve 22b are opened or closed at predetermined timings by the rotation of the crankshaft 12 via the camshaft 23 and rocker arms 25a, 25b.

As shown in FIG. 2, a transmission case 31 is connected to the crankcase 11. Inside the transmission case 31, belt-typed continuously variable transmission 32 is assembled. The continuously variable transmission 32 has a primary shaft 33 and a secondary shaft 34, both rotatably mounted in the transmission case 31. The primary shaft 33 is provided coaxially to the crankshaft 12. The secondary shaft 34 is in parallel to the primary shaft 33. The primary shaft 33 is connected to a clutch drum 36 of a centrifugal clutch 35 which is provided to couple the primary shaft 33 and the crankshaft 12.

A primary pulley 37 is provided on the primary shaft 33. The primary pulley 37 is composed of a fixed pulley sheave 37a fixed on and integrally rotated with the primary shaft 33 and a movable pulley sheave 37b integrally rotated with the primary shaft 33 and slidable in an axial direction of the primary shaft 33, thereby to provide a groove between the fixed pulley sheave 37a and the movable pulley sheave 37b, the width of which is variably changed. A secondary pulley 38 is provided on the secondary shaft 34. The secondary pulley 38 is composed of a fixed pulley sheave 38a fixed on and integrally rotated with the secondary shaft 34 and a movable pulley sheave 38b integrally rotated with the secondary shaft 34 and slidable in an axial direction of the secondary shaft 34, thereby to provide a groove between the fixed pulley sheave 38a and the movable pulley sheave 38b, the width of which is variably changed. A V-belt 39 made of rubber is looped over the primary pulley 37 and the secondary pulley 38. The rotation of the primary shaft 33 is transmitted to the secondary shaft 34 in a transmission gear ration which can be continuously variable depending on the change in a diameter of a loop of the V-belt 39 looped over the primary pulley 37 and a diameter of a loop of the V-belt 39 looped over the secondary pulley 38. A plurality of cylindrical centrifugal weights 42 are mounted on the primary pulley 37 by a cam plate 41 fixed to the primary shaft 33 in a direction perpendicular to the rotary axis of the primary shaft 33. In order to add a force for clamping and extending the V-belt 39 in the pulley grooves, the secondary shaft 34 is provided with a compression coil spring 43.

Therefore, in a state where the rotation speed of the crankshaft 12 is increased more than a predetermined speed and the primary shaft 33 and the crankshaft 12 are coupled by the centrifugal clutch 35, the centrifugal weights 42 are moved outwardly in the radial direction by centrifugal forces applied thereto depending on the increase of the rotation speed of the primary shaft 33, thereby to narrow the groove width of the primary pulley 37 to increase the diameter of a loop of the V-belt 39 looped over this primary pulley 37. With this, the groove width of the secondary pulley 38 is widened against the spring force to decrease the diameter of a loop of the V-belt 39 looped over the secondary pulley 38, thereby to vary the transmission gear ratio of the continuously variable transmission 32 to a higher speed side.

As shown in FIG. 2, a gear case 44 is mounted on the transmission case 31. In the gear case 44, the secondary shaft 34 is supported. In addition, a counter shaft 45 is rotatably mounted parallel to the secondary shaft 34. Further, an axle 46 is rotatably mounted in parallel to the counter shaft 45. The axle 46 is directly connected to rear wheels 3a, 3b shown in FIG. 1. Between the secondary shaft 34 and the counter shaft 45, there are provided a forward gear train 47 and a reverse gear train 48. The forward gear train 47 comprises a driving gear 47a provided integrally with the secondary shaft 34 and a driven gear 47b mounted rotatably with the counter shaft 45. The reverse gear train 48 comprises a driving gear 48a provided integrally with the secondary shaft 34, a driven gear 48b mounted on the counter shaft 45 rotatably, and an idler gear not shown which is engaged with the driving gear 48a and the driven gear 48b.

In order to switch the rotational direction of the counter shaft 45, a forward and reverse switching mechanism 49 is mounted on the counter shaft 45. The forward and reverse switching mechanism 49, as shown in FIG. 2, has switching disks 51a, 51b each engaged with the spline formed on the counter shaft 45 and slidable in an axial direction of the counter shaft 45. When the switching disk 51a is engaged with the forward gear train 47, the rotation of the secondary shaft 34 is transmitted to the axle 46 to move the vehicle forwardly. On the other hand, when the switching disk 51b is engaged with the reverse gear train 48, the rotation of the secondary shaft 34 is transmitted to the axle 46 to move the vehicle backwardly.

As shown in FIG. 2, on the crankcase 11, a balancer shaft 52 is mounted rotatably in parallel to the crankshaft 12. The balancer shaft 52 is coupled on the crankshaft 12 via a gear train 53. With the balancer shaft 52, a balance weight 54 is integrally provided, in addition, on the balancer shaft 52, a rotor of an oil pump 55 is mounted. A lubricant oil discharged from the oil pump 55 is supplied to a sliding portion in power transmission system via oil path not shown.

On the crankcase 11, as shown in FIG. 2, a generator case 56 is mounted, in the generator case 56, a generator 57 is provided. The generator 57 has an outer rotor 58 attached to the crankshaft 12 and a stator 59 attached to the crankcase 11. Therefore, when the engine 13 is activated to rotate the crankshaft 12, electric power generated by the generator 57 is charged into a battery not shown.

Accordingly the crankcase 11, the transmission case 31, the gear case 44, and the generator case 56 are integrated as the power transmission system and mounted on the vehicle.

A starter 61 is mounted in the generator case 56 and driven by an electric motor 62 attached to the crankcase 11. In a case where an amount of charge of the battery lacks so that the engine 13 is not able to start by the starter 61, in order to start the engine 13 by hand, a recoil starter 63 is mounted in the generator case 56. The recoil starter 63 has a recoil pulley 64 wound by a recoil rope. By pulling the recoil rope to rotate the recoil pulley 64, crankshaft 12 is rotated thereby starting the engine 13 even by hand.

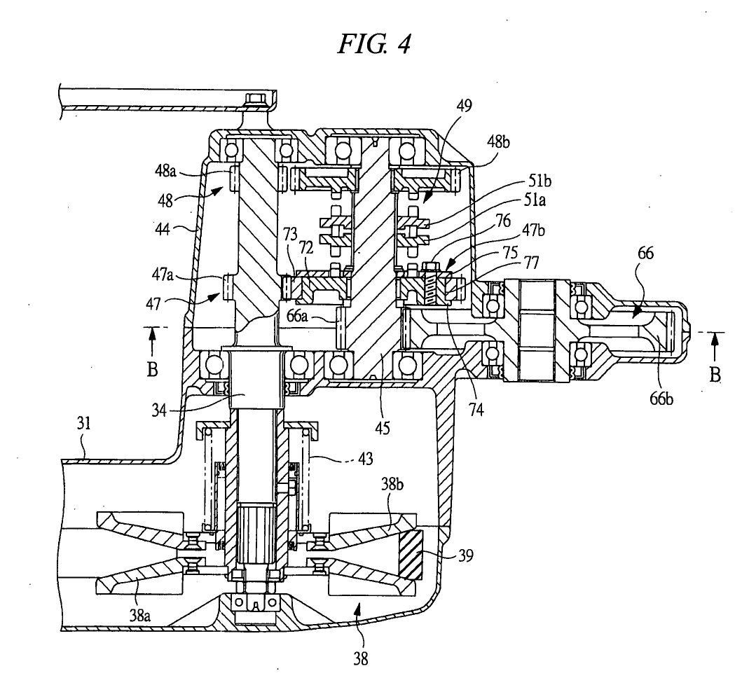

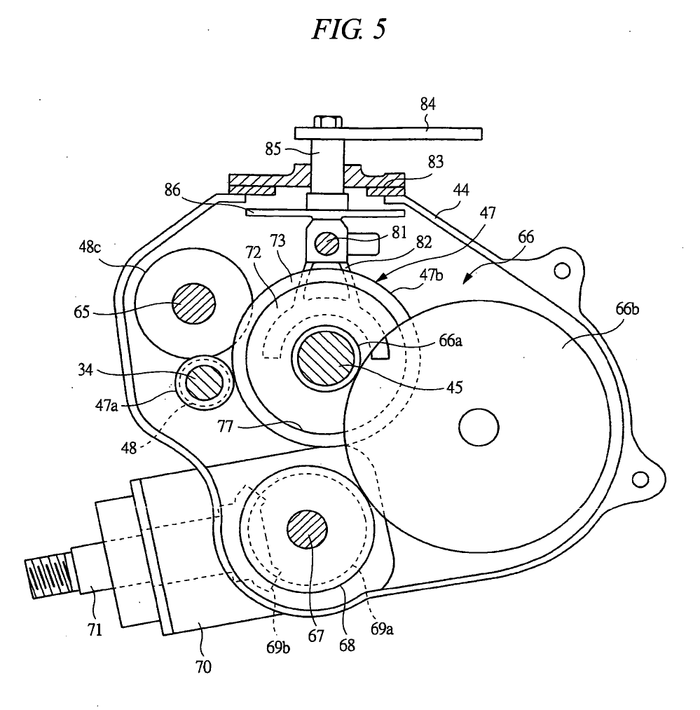

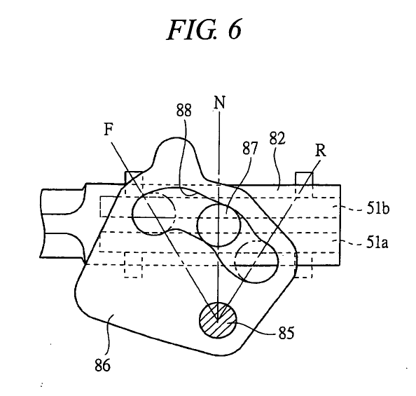

FIG. 4 is cross-sectional view showing by enlarging a part of FIG. 2. FIG. 5 is a cross sectional view along a line B-B in FIG. 4. FIG. 6 is a plan view showing the switching plate as shown in FIG. 5. Further, in FIG. 5, in respect to gears, only each pitch circle is shown by solid line. Addendum circle and dedendum circle are omitted. As shown by FIG. 5, an idler shaft 65 is mounted and extended in the transmission case 31 and the gear case 44. On the idler shaft 65, an idler gear 48c which engages with the driving gear 48a and the driven gear 48b is rotatably mounted.

A final reduction drive gear 66a is provided on the counter shaft 45. A final reduction driven gear 66b, which engages with the final reduction drive gear 66a is provided on the axle 46. These gears 66a, 66b compose a final reduction gear train 66. As shown in FIG. 2, the final reduction driven gear 66b is directly linked to the axle 46 and as shown in FIG. 5 is engaged with a gear 68 secured on an additional shaft 67. The additional shaft 67 is rotatably mounted in the case. On the additional shaft 67, a bevel gear 69a is secured. A bevel gear 69b engaged with the bevel gear 69a is secured at the end of a front wheels driving shaft 71. The bevel gear 69b is located in a storage case 70 attached to the gear case 44. The front wheels driving shaft 71 is operatively connected to the front wheels 2a, 2b via a propeller shaft (not shown) which is provided outside the storage case 70.

The forward gear train 47 composed of the driven gear 47b is formed of, as shown in FIGS. 4 and 5, a disk portion 72 mounted rotatably on the counter shaft 45 and a circular gear portion 73 fitted into externally circumferential surface of the disk portion 72. One side edge of the circular gear portion 73 is abutted on a step portion 74 formed at the disk portion 72. A stopper plate 75 abutted on the other side edge of the circular gear portion 73 is fixed to the disk portion 72 by a plurality of bolts 76. Each of the externally circumferential surface of the disk portion 72 and an internally circumferential surface of the circular gear portion 73 is a fitting surface 77. At least either of the fitting surfaces is processed such that coefficient of friction is lowered such as a sulfurizing process. This fitting structure between the disk portion 72 and the circular gear portion 73 provides a torque limiter mechanism to avoid excess torque input from the driving wheels into the power transmission system, i.e. at the landing of a jumping vehicle. That is, when the driving wheels recover driving reaction torque at the landing after jumping, slippage occurs between the disk portion 72 and the circular gear portion 73 so that transmission of excess torque from the driving wheels is blocked.

Since the forward gear train 47 is disposed at the engine side than the final reduction gear train 66, a spike torque to be added to the forward driven gear 47b is less than a torque to be added to the final reduction gear train 66. Accordingly, a spike torque limiter value as an acceptance torque value can be set to a smaller value. It is not only easy to set the acceptance torque value but also inexpensive and high yield to manufacture the power transmission system. Moreover, since the forward gear train 47 is disposed in the gear case 44, there is no fear of corruption on the fitting surface of the torque limiter mechanism, thereby enhancing reliability of the power transmission system. Further, also similarly as regards the driven gear 48b of the reverse gear train 48, it may be formed of the disk portion and the circular gear portion fitting each other to provide the torque limiter structure.

In order to switch vehicle driving mode between the forward driving and reverse driving, a switching holder 82 is slidably mounted on a guide rod 81 fixed to the gear case 44 in parallel to the counter shaft 45. The switching holder 82 is operatively connected to the switching disks 51a, 51b. On one hand, on a cover 83 fixed to the gear case 44, a rotation shaft 85 having an operating link 84 at its end is rotatably mounted. A switching plate 86 is fixed to the rotation shaft 85. To the operating link 84, as shown in FIG. 1, a switching lever 6 which is mounted on the vehicle is operatively connected. A driver operates the switching lever 6, thereby turning the switching plate 86 via the operating link 84. At the switching plate 86, as shown in FIG. 6, a cam groove 88 with which an engaging pin 87 fixed to the switching holder 82 engages is formed. The switching plate 86, as shown in FIG. 6, turns at the range of N-position, F-position, and R-position. When the switching plate 86 is at F-position, the forward driven gear 47b is operatively coupled to the counter shaft 45 via the switching disk 51a to transmit the engine power to the driving wheels. On the other hand, when the switching plate 86 is at R-position, the reverse driven gear 48b is operatively coupled to the counter shaft 45 via the switching disk 51b to transmit the engine power to the driving wheels. At N-position, both of the forward gear train 47 and the reverse gear train 48 are at neutral position to block the power transmission.

It should be understood that the present invention is not limited to the above-mentioned embodiments but can be variously modified within the sprit and scope of the present invention. For example, the same torque limiter mechanism can be also applied to the drive gear 47a of the forward gear train 47. Moreover, although in the power transmission system of the present invention, the crankshaft 12 and the primary shaft 33 of the belt-type continuously variable transmission are disposed coaxially, the present invention can be applied to a power transmission system in which the crankshaft and the primary shaft are offset.

### CROSS-REFERENCE TO RELATED APPLICATION

The present application claims priority from Japanese Patent Application JP 2004-140271 filed on May 10, 2004, the content of which is hereby incorporated by reference into this application.

1. A power transmission system of a vehicle for transmitting power of an engine to a driving wheel, the power transmission system comprising:
a transmission having an input shaft and an output shaft, the input shaft being operatively connected to the engine;
a counter shaft provided in parallel with the output shaft of the transmission;
a forward gear train provided between the output shaft of the transmission and the counter shaft; and
a final reduction gear train provided between the counter shaft and an axle, the axle being operatively connected to the driving wheel;
wherein the forward gear train includes a gear having a disk portion mounted on the shaft and a circular gear portion fitted on an external circumference of the disk portion.

2. The power transmission system according to claim 1, wherein the gear of the forward gear train is a driven gear mounted on the counter shaft.

3. The power transmission system according to claim 1, comprising:
a forward and reverse changeover mechanism provided on the counter shaft to change over vehicle driving mode between a forward driving and a reverse driving;
wherein the forward gear train is provided for the forward driving and operatively coupled to the counter shaft by the forward and reverse changeover mechanism at the selection of the forward driving.

4. The power transmission system according to claim 1, wherein the transmission is a continuously variable transmission having a primary pulley, a secondary pulley and a driving belt wound over the primary pulley and secondary pulley.

5. The power transmission system according to claim 1, wherein the disk portion and the circular gear portion of the driven gear are fitted each other and at least one of the surfaces of the disk portion and the circular gear portion is processed to be low friction surface.
